(19) United States
(12) Patent Application Publication
(10) Pub. No.: US 2026/0057290 A1
(43) Pub. Date: Feb. 26, 2026

(54) METHOD TO LEARN AND PREDICT CONTEXTS IN WHICH VEHICLE TYPES HIT GUARDRAILS AND THE RELATED CONSEQUENCES

(71) Applicant: HERE GLOBAL B.V., EINDHOVEN (NL)

(72) Inventor: JEROME BEAUREPAIRE, NANTES (FR)

(73) Assignee: HERE GLOBAL B.V., EINDHOVEN (NL)

(21) Appl. No.: 18/811,772

(22) Filed: Aug. 22, 2024

(51) Int. Cl. G06N 20/00

(52) U.S. Cl. CPC G06N 20/00

(57) ABSTRACT

A system to determine a context and likelihood of a vehicle hitting a guardrail is disclosed. The system is configured to detect, by sensors, where a vehicle hits a guardrail in one or more guardrail collision events; determine metadata elements associated with the one or more guardrail collision events; mapping the one or more guardrail collision events to a region into a vector format; determine, using a first trained machine learning model, a first likelihood if a given vehicle will hit a guardrail in the region on a given link at a given time based on the mapped guardrail collision events and a training feature dataset; and determine, using a second trained machine learning model, a second likelihood that the given vehicle will go over the guardrail into an unsafe area based on the first likelihood and guardrail collision features.

### TECHNOLOGICAL FIELD

An example aspect of the present disclosure generally relates to promoting vehicle safety when encountering guard rails, and more particularly, but without limitation relates to a system, a method, and a computer program product to learn and predict contexts in which certain vehicle types hit guardrails and the related consequences of such decisions.

### BACKGROUND

Vehicles during travel may occasionally stray into dangerous or off-limit areas, typically on bridges, medians and curves. A guardrail is a barrier that is designed to protect drivers from veering off the road or into oncoming traffic. It typically consists of a series of metal or wooden posts that are supported by horizontal beams and is typically installed along the edge of a roadway. Guardrails are used to provide a physical barrier to prevent vehicles from leaving the roadway, and they can also help to reduce the severity of crashes when they do occur by absorbing some of the impact energy. They are commonly found on roads with steep drops, sharp curves, or other hazards that may cause drivers to lose control of their vehicles.

Guardrails are an important safety feature on roads and highways and are used to help protect drivers and passengers from harm. Guardrails are designed to protect drivers from veering off the road or into oncoming traffic by providing a physical barrier to prevent vehicles from leaving the roadway.However, there are some circumstances under which guardrails can be dangerous for cars.

For example, if a driver is traveling at a high speed and strikes a guardrail head-on, the impact can be severe and may cause significant damage to the vehicle and its occupants. Similarly, if a vehicle becomes trapped between the guardrail and another object, such as a bridge pillar, the occupants may be at risk of injury or death.

Guardrails can be dangerous for motorbikes in some situations because they are designed to stop larger, heavier vehicles, such as cars and trucks. When a motorbike hits a guardrail, the impact can be more severe for the rider because the bike itself is smaller and lighter than a car. The rider may also be more vulnerable to injury because they are not as well protected as a driver in a car. In addition, the smaller size of a motorbike can make it more likely to become trapped between the guardrail and another object, which can increase the risk of injury to the rider. They are also more likely to slide against the guardrail, fall under it or land or it.

Guardrails can be effective at improving safety for heavy trucks in some situations. They are designed to provide a physical barrier to prevent vehicles from leaving the roadway, and they can help to reduce the severity of crashes when they do occur by absorbing some of the impact energy. However, it is worth noting that guardrails are typically more effective at protecting smaller, lighter vehicles, such as cars and SUVs, than they are at protecting larger, heavier vehicles like trucks. This is because the size and weight of a heavy truck can make it more difficult for a guardrail to absorb the impact energy and stop the vehicle.

It is clear that a method to predict the context in which a particular vehicle type hits a guardrail and the consequences of such impact is needed to better safeguard such vehicles and their occupants.

### BRIEF SUMMARY

The present disclosure provides a system, a method and a computer program product to learn and predict contexts in which certain vehicle types hit guardrails and the related consequences of such decisions, in accordance with various aspects.

Aspects of the disclosure provide a computer implemented method to determine a context and likelihood of a vehicle hitting a guardrail. The method may include detecting, by sensors, where a vehicle hits a guardrail in one or more guardrail collision events; determining metadata elements associated with the one or more guardrail collision events; mapping the one or more guardrail collision events to a region into a vector format; determining, using a first trained machine learning model, a first likelihood if a given vehicle will hit a guardrail in the region on a given link at a given time based on the mapped guardrail collision events and a training feature dataset; and determining, using a second trained machine learning model, a second likelihood that the given vehicle will go over the guardrail into an unsafe area based on the first likelihood and guardrail collision features.

Aspects of the disclosure may provide a system to determine a context and likelihood of a vehicle hitting a guardrail. The system may include at least one memory configured to store computer executable instructions; and at least one processor configured to execute the computer executable instructions to: detect, by sensors, where a vehicle hits a guardrail in one or more guardrail collision events; determine metadata elements associated with the one or more guardrail collision events; map the one or more guardrail collision events to a region into a vector format; determine, using a first trained machine learning model, a first likelihood if a given vehicle will hit a guardrail in the region on a given link at a given time based on the mapped guardrail collision events and a training feature dataset; and determine, using a second trained machine learning model, a second likelihood that the given vehicle will go over the guardrail into an unsafe area based on the first likelihood and guardrail collision features.

Aspects of the disclosure may provide a computer program product comprising a non-transitory computer readable medium having stored thereon computer executable instructions, which when executed by one or more processors, cause the one or more processors to carry out operations to determine a context and likelihood of a vehicle hitting a guardrail. The operations may include operations for: detecting, by sensors, where a vehicle hits a guardrail in one or more guardrail collision events; determining metadata elements associated with the one or more guardrail collision events; mapping the one or more guardrail collision events to a region into a vector format; determining, using a first trained machine learning model, a first likelihood if a given vehicle will hit a guardrail in the region on a given link at a given time based on the mapped guardrail collision events and a training feature dataset; and determining, using a second trained machine learning model, a second likelihood that the given vehicle will go over the guardrail into an unsafe area based on the first likelihood and guardrail collision features.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF THE DRAWINGS

Having thus described certain aspects of the disclosure in general terms, reference will now be made to the accompanying drawings, which are not necessarily drawn to scale, and wherein:

FIG. 1 illustrates a schematic diagram of a network environment 100 of a system 102 for determining a context and likelihood of a vehicle hitting a guardrail, in accordance with an example aspect;

FIG. 2 illustrates a block diagram of the system for determining a context and likelihood of a vehicle hitting a guardrail, in accordance with an example aspect;

FIG. 3 illustrates an example the map or geographic database for use by the system for determining a context and likelihood of a vehicle hitting a guardrail, in accordance with an example aspect; and

FIG. 4 illustrates a flowchart 400 for acts taken in an exemplary method for determining a context and likelihood of a vehicle hitting a guardrail, in accordance with an aspect.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

For purposes of this disclosure, though not limiting or exhaustive, “vehicle” refers to standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle (AV) may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one aspect, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

There are several reasons why it is important to determine the contexts for which vehicles are more likely to hit guardrails

For safety purposes:

By better understanding contexts leading to such accidents, drivers, riders and road designers can take proactive actions. By context, with respect to the disclosure, it is meant:

When it happens (day, hour, seasonality, day/night, etc);

Where it happens (location, characteristics and attributes of that location);

Other environmental conditions (weather, traffic, etc);

User's conditions (stressed, relaxed, on her/his commute or on an unfamiliar route, etc); and other situations and parameters.

Vehicles hitting guardrails can lead to dangerous situations for all the parties involved:

The vehicle hitting that guardrail; and

All vehicles that need to react to it (brake, avoid, etc) or that are involved in an accident with it.

Therefore there is a need to better understand when and where such events occur, what leads to dangerous situations and whether something can be done to limit the risk of accidents.

In an aspect of the disclosure, a system to predict the likelihood and consequence of vehicles hitting a guardrail may be aided with a trained machine learning (ML) model to predict such likelihoods.

In an aspect, the system may detect where vehicles hit guardrails. This detection may be performed in different ways:

Probe data collected from vehicles and surrounding locations;

Front facing cameras in vehicles;

Cameras from other vehicles;

Using head-mounted devices/glasses;

Use cars' sensors or other vehicles' sensors, such as cameras, LiDAR and other sensors;

Using traffic/safety cameras, and other potential sensor and camera data.

In addition, the system may collect and process metadata to understand the context of guardrail collisions. Additional elements related to those events where vehicles hit guardrails can be collected as well by the system:

Time of the event;

Start of the event;

Duration/length of the event;

End of event;

Number of vehicles impacted by the event (which had to brake/avoid/deviate from original route);

Speed of the vehicle;

Weather conditions;

Visibility;

Traffic conditions;

Which functional class the user is driving on (Highway or city center); and other metadata related to the collision event in question.

The applications of the system may be available for other transport modes and pedestrian traffic as well.

In an aspect of the disclosure, the system may map the collision events so the system can learn about them. Once the system is able to detect where vehicles hit guardrails, these can be labeled on a map, together with their characteristics. For example, the events can be mapped at the link level, considering the offset on the links. Or, in another aspect, they can be aggregated on a different spatial entity.

Once each observation has been translated into a vector format suitable to be used as a feature vector for machine learning, desired output value must be formulated, and both used to train a machine model on the resulting (observation, output) pairs. In an aspect, the ML training may be a standard regression or classification task.

In an aspect of the disclosure, a first ML model (ML-1) is used to predict if a vehicle will hit a guardrail on a given link at a given time, considering certain features:

1. Type of vehicle (small car, sedan, small truck, large truck, utility, motorbike);

2. Traffic conditions;

3. Day / night;

4. Functional classes (highway, city center, rural roads, etc);

5. Type of guardrail (material, size, etc);

6. Road width;

7. Presence of physical divider;

8. Extreme weather conditions (heavy rain, fog);

9. Vehicle speed;

10. Heading degree difference (Vehicle heading degree - Link heading degree);

11. Incidence angle (vehicle against guardrail);

12. Road curvature;

13. Road ascent/descent degree;

14. Road works;

15. Presence of tree or infrastructure on the edge of the road (Yes/ No);

16. Type of transmission (automatic or manual); and other relevant features.

In an aspect, the system may then label whether the vehicle has hit a guardrail. Historic data is collected for the features and the corresponding label. Then, according to an aspect of the disclosure, the first ML model (ML-1) is trained on this data. Whenever a vehicle starts driving, the current features are extracted from maps and sensors and fed into the trained ML model. In an aspect, the model predicts whether the vehicle will hit a guardrail given the current context. In an aspect, the probability score varies from 0 to 1. With the inputs described above, the system is then able to learn when and where vehicles will hit a guardrail.

In an aspect of the disclosure, a second ML model (ML-2) can be created to learn if and where vehicles are going over the guardrail (partly or fully) and end up in an “unsafe” area, which the guardrail was protecting from. In an aspect, if the output of the ML-1 is above a threshold value (e.g., 0.7) then the same features are passed through ML-2.

In an aspect, for ML-2 the features may be same but the labels may change. For example, predicting the likelihood for a given vehicle type to go over the guardrail will likely rely more on features like incidence angle, speed, slope, etc.

In an aspect, the label has two outputs, which are Yes and No.

Yes = High probability of vehicle going over the guardrail; and No = Low probability of a vehicle going over the guardrail.

In an aspect, the output of the ML_2 is also a probability score ranging from 0 to 1. If the output of the ML-2 is greater than a threshold value (e.g., 0.7) then there is a fair chance of the vehicle ending up on the other side of the guardrail.

In a further aspect, another model may be trained to determine which of the guardrails have successfully fulfilled their purposes and protected vehicles from a more dangerous situation like going on the other side of it. Using those learnings, the system would be able to highlight the locations with similar patterns and characteristics that would likely benefit from guardrails, to make those areas safer. In a similar way, the system could make recommendation as to which type of guardrail to install at a given dangerous location (new guardrail or replacement).

In an aspect of the disclosure, once such models have been established, transfer learning could be applied to benefit from it in areas where historical information is not available. Those models would be used as a baseline until data can be collected in such area and the model can be fine-tuned for the new areas to better match local behaviors and situations.

In an aspect, the system could leverage historical information (mobility graph) from a given user or set of users (e.g., commuters) who may tend to accomplish the same actions or patterns (eg. driving fast in curves) at the same locations due to habits. Such information about repeated patterns would be useful for the system to learn and make even more accurate predictions. The system could for example determine that some accidents involving vehicles hitting guardrails are more likely to happen with people familiar with the area because they tend to drive faster. Or, on the opposite, in some other cases, accidents could involve more drivers unfamiliar with the area who tend to be surprised by a very curvy road by night.

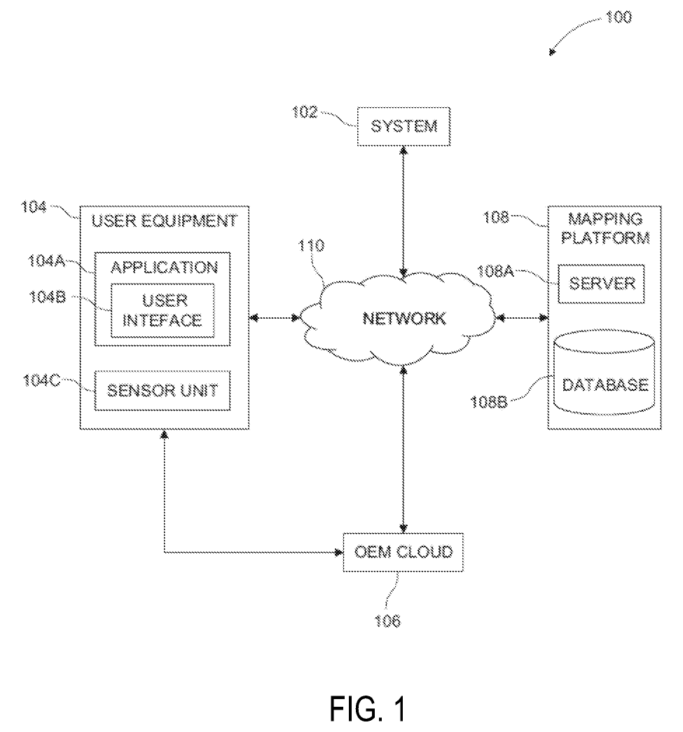

FIG. 1 illustrates a schematic diagram of a network environment 100 of a system 102 for determining a context and likelihood of a vehicle hitting a guardrail in accordance with an example aspect. The system 102 may be communicatively coupled with, a user equipment (UE) 104, an OEM cloud 106, a mapping platform 108, via a network 110. The UE 104 may be a vehicle electronics system, onboard automotive electronics/computers, a mobile device such as a smartphone, tablet, smart watch, smart glasses, laptop, wearable device or other UE platforms known to one of skill in the art. The mapping platform 108 may further include a server 108A and a database 108B. The user equipment includes an application 104A, a user interface 104B, and a sensor unit 104C. Further, the server 108A and the database 108B may be communicatively coupled to each other.

The system 102 may comprise suitable logic, circuitry, interfaces and code that may be configured to process the sensor data obtained from the UE 104 for road and weather conditions in a region, that may be used to assist a user or driver to determine a context and likelihood of a vehicle hitting a guardrail. Such features can also include a type of vehicle; traffic conditions; day or night when the one or more guardrail collision events occurs; afunctional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof.

The system 102 may be communicatively coupled to the UE 104, the OEM cloud 106, and the mapping platform 108 directly via the network 110. Additionally, or alternately, in some example aspects, the system 102 may be communicatively coupled to the UE 104 via the OEM cloud 106 which in turn may be accessible to the system 102 via the network 110.

All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed. Furthermore, fewer or additional components may be in communication with the system 102, within the scope of this disclosure.

The system 102 may be embodied in one or more of several ways as per the required implementation. For example, the system 102 may be embodied as a cloud-based service or a cloud-based platform. As such, the system 102 may be configured to operate outside the UE 104. However, in some example aspects, the system 102 may be embodied within the UE 104. In each of such aspects, the system 102 may be communicatively coupled to the components shown in FIG. 1 to carry out the desired operations and wherever required modifications may be possible within the scope of the present disclosure.

The UE 104 may be a vehicle electronics system, onboard automotive electronics/computers, a mobile device such as a smartphone, tablet, smart watch, smart glasses, laptop, wearable device and the like that is portable in itself or as a part of another portable/mobile object, such as, a vehicle known to one of skill in the art. The UE 104 may comprise a processor, a memory and a network interface. The processor, the memory and the network interface may be communicatively coupled to each other. In some example aspects, the UE 104 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example aspects, the UE 104 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the UE 104. Additional, different, or fewer components may be provided. For example, the UE 104 may be configured to execute and run mobile applications such as a messaging application, a browser application, a navigation application, and the like. In accordance with an aspect, the UE 104 may be directly coupled to the system 102 via the network 110. For example, the UE 104 may be a dedicated vehicle (or a part thereof) for gathering data for development of the map data in the database 108B. In some example aspects, the UE 104 may be coupled to the system 102 via the OEM cloud 106 and the network 110. For example, the UE 104 may be a consumer mobile phone (or a part thereof) and may be a beneficiary of the services provided by the system 102. In some example aspects, the UE 104 may serve the dual purpose of a data gatherer and a beneficiary device. The UE 104 may be configured to provide sensor data to the system 102. In accordance with an aspect, the UE 104 may process the sensor data for information that may be used for determining a context and likelihood of a vehicle hitting a guardrail, such as weather, traffic conditions, construction, visibility, windy roads, etc. Further, in accordance with an aspect, the UE 104 may be configured to perform processing related to determining a context and likelihood of a vehicle hitting a guardrail.

The UE 104 may include the application 104A with the user interface 104B to access one or more applications. The application 104B may correspond to, but not limited to, map related service application, navigation related service application and location-based service application. In other words, the UE 104 may include the application 104A with the user interface 104B. The user interface 104B may be a dedicated user interface configured to show potential locations or contexts of guardrail collision events in the area. The user interface 104B may be in the form of a map depicting regions heightened risk of guardrail collision, according to aspects of the disclosure.

The sensor unit 104C may be embodied within the UE 104. The sensor unit 104C comprising one or more sensors may capture sensor data, in a certain geographic location. In accordance with an aspect, the sensor unit 104C may be built-in, or embedded into, or within interior of the UE 104. The one or more sensors (or sensors) of the sensor unit 104C may be configured to provide the sensor data comprising location data associated with a location of a user. In accordance with an aspect, the sensor unit 104C may be configured to transmit the sensor data to an Original Equipment Manufacturer (OEM) cloud. Examples of the sensors in the sensor unit 104C may include, but not limited to, a microphone, a camera, an acceleration sensor, a gyroscopic sensor, a LIDAR sensor, a proximity sensor, and a motion sensor.

The sensor data may refer to sensor data collected from a sensor unit 104C in the UE 104. In accordance with an aspect, the sensor data may be collected from a large number of mobile phones. In accordance with an aspect, the sensor data may refer to the point cloud data. The point cloud data may be a collection of data points defined by a given coordinates system. In a 3D coordinates system, for instance, the point cloud data may define the shape of some real or created physical objects. The point cloud data may be used to create 3D meshes and other models used in 3D modelling for various fields. In a 3D Cartesian coordinates system, a point is identified by three coordinates that, taken together, correlate to a precise point in space relative to a point of origin. The LIDAR point cloud data may include point measurements from real-world objects or photos for a point cloud data that may then be translated to a 3D mesh or NURBS or CAD model. In accordance with an aspect, the sensor data may be converted to units and ranges compatible with the system 102, to accurately receive the sensor data at the system 102. Additionally, or alternately, the sensor data of a UE 104 may correspond to movement data associated with a user of the user equipment. Without limitations, this may include motion data, position data, orientation data with respect to a reference and the like.

The mapping platform 108 may comprise suitable logic, circuitry, interfaces and code that may be configured to store map data associated with a geographic area in the region of interest related to geographic or other physical features that may lead to heightened risk of guardrail collision events, etc. The map data may include traffic features and include historical (or static) traffic features such as road layouts, pre-existing road networks, business, educational and recreational locations, POI locations, historical and real-time weather conditions in the region or a combination thereof. The server 108A of the mapping platform 108 may comprise processing means and communication means. For example, the processing means may comprise one or more processors configured to process requests received from the system 102 and/or the UE 104. The processing means may fetch map data from the database 108B and transmit the same to the system 102 and/or the UE 104 in a suitable format. In one or more example aspects, the mapping platform 108 may periodically communicate with the UE 104 via the processing means to update a local cache of the map data stored on the UE 104. Accordingly, in some example aspects, map data may also be stored on the UE 104 and may be updated based on periodic communication with the mapping platform 108.

In an aspect, the map data may include, and the database 108B of the mapping platform 108 may store real-time, dynamic data about features determine a context and likelihood of a vehicle hitting a guardrail. For example, real-time data may be collected for determining a context and likelihood of a vehicle hitting a guardrail, such as a type of vehicle; traffic conditions; day or night when the one or more guardrail collision events occurs; a functional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof. Other data records may include computer code instructions and/or algorithms for executing a trained machine learning model that is capable of determining a context and likelihood of a vehicle hitting a guardrail.

The database 108B of the mapping platform 108 may store map data of one or more geographic regions that may correspond to a city, a province, a country or of the entire world. The database 108B may store point cloud data collected from the UE 104. The database 108B may store data such as, but not limited to, node data, road segment data, link data, point of interest (POI) data, link identification information, and heading value records. The database 108B may also store cartographic data, routing data, and/or maneuvering data. According to some example aspects, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities for identifying location of building.

Optionally, the database 108B may contain path segment and node data records, such as shape points or other data that may represent raised features and vehicle speed control indications, links or areas in addition to or instead of the vehicle road record data. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 108B may also store data about the POIs and their respective locations in the POI records. The database 108B may additionally store data about places, such as cities, towns, or other communities, and other geographic features such as bodies of water, and mountain ranges. Such place or feature data can be part of the POI data or can be associated with POIs or POI data records (such as a data point used for displaying or representing a position of a city). In addition, the database 108B may include event data (e.g., traffic incidents, construction activities, scheduled events, unscheduled events, accidents, diversions etc.) associated with the POI data records or other records of the database 108B. Optionally or additionally, the database 108B may store 3D building maps data (3D map model of objects) of structures, topography and other visible features surrounding roads and streets, including raised features on the roads.

The database 108B may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the UE 104. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the database 108B may be a master geographic database, but in alternate aspects, the database 108B may be embodied as a client-side map database and may represent a compiled navigation database that may be used in or with end user devices (such as the UE 104) to provide navigation and/or map-related functions. In such a case, the database 108B may be downloaded or stored on the end user devices (such as the UE 104).

The network 110 may comprise suitable logic, circuitry, and interfaces that may be configured to provide a plurality of network ports and a plurality of communication channels for transmission and reception of data, such as the sensor data, map data from the database 108B, etc. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 110 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 110 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) networks (for e.g. LTE-Advanced Pro), 5G New Radio networks, ITU-IMT 2020 networks, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The system, apparatus, method and computer program product described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, method and computer program product may be configured to determine a context and likelihood of a vehicle hitting a guardrail may similarly be embodied by the same or different server, computer workstation, distributed network of computing devices, personal computer, or other type of computing device.

Alternatively, the system, apparatus, method and computer program product may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

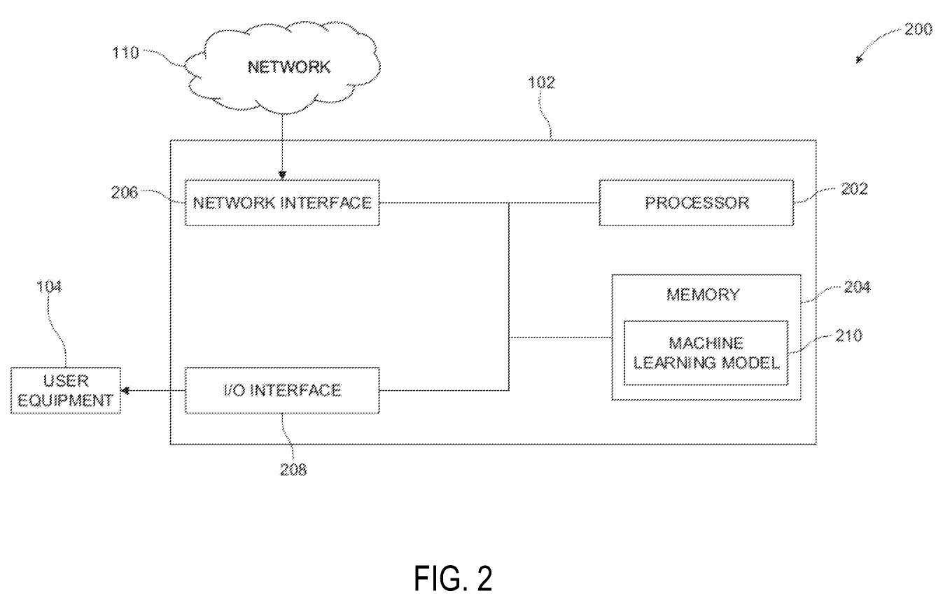

FIG. 2 illustrates a block diagram 200 of the system 102, exemplarily illustrated in FIG. 1, to determine a context and likelihood of a vehicle hitting a guardrail, in accordance with an example aspect. FIG. 2 is described in conjunction with elements from FIG. 1.

As shown in FIG. 2, the system 102 may comprise a processing means such as a processor 202, storage means such as a memory 204, a communication means, such as a network interface 206, an input/output (I/O) interface 208, and a machine learning model 210. The processor 202 may retrieve computer executable instructions that may be stored in the memory 204 for execution of the computer executable instructions. The system 102 may connect to the UE 104 via the I/O interface 208. The processor 202 may be communicatively coupled to the memory 204, the network interface 206, the I/O interface 208, and the machine learning model 210.

The processor 202 may comprise suitable logic, circuitry, and interfaces that may be configured to execute instructions stored in the memory 204. The processor 202 may obtain sensor data associated with guardrail collision events. The sensor data may be captured by one or more UE, such as the UE 104. The processor 202 may be configured to determine a context and likelihood of a vehicle hitting a guardrail, based on the sensor data. The processor 202 may be further configured to determine, using a trained machine learning model in conjunction with ground truth of the region, to predict a a first likelihood if a given vehicle will hit a guardrail in the region on a given link at a given time based on the mapped guardrail collision events and a training feature dataset, where the ground truth of a region comprises current features of a link and incidence of guardrail collisions.

Examples of the processor 202 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits. The processor 202 may implement a number of processor technologies known in the art such as a machine learning model, a deep learning model, such as a recurrent neural network (RNN), a convolutional neural network (CNN), and a feed-forward neural network, or a Bayesian model. As such, in some aspects, the processor 202 may include one or more processing cores configured to perform independently. A multi-core processor may enable multiprocessing within a single physical package.

Additionally, or alternatively, the processor 202 may include one or more processors configured in tandem via the bus to enable independent execution of instructions, pipelining and/or multithreading. Additionally, or alternatively, the processor 202 may include one or processors capable of processing large volumes of workloads and operations to provide support for big data analysis. However, in some cases, the processor 202 may be a processor specific device (for example, a mobile terminal or a fixed computing device) configured to employ an aspect of the disclosure by further configuration of the processor 202 by instructions for performing the algorithms and/or operations described herein.

In some aspects, the processor 202 may be configured to provide Internet-of-Things (IoT) related capabilities to users of the UE 104 disclosed herein. The IoT related capabilities may in turn be used to provide smart city solutions by providing real time weather and road updates, big data analysis, and sensor-based data collection for providing navigation and charging locations near critical areas. The environment may be accessed using the I/O interface 208 of the system 102 disclosed herein.

The memory 204 may comprise suitable logic, circuitry, and interfaces that may be configured to store a machine code and/or instructions executable by the processor 202. The memory 204 may be configured to store information including processor instructions for training the machine learning model. The memory 204 may be used by the processor 202 to store temporary values during execution of processor instructions. The memory 204 may be configured to store different types of data, such as, but not limited to, sensor data from the UE 104. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, and interfaces that may be configured to communicate with the components of the system 102 and other systems and devices in the network environment 100, via the network 110. The network interface 206 may communicate with the UE 104, via the network 110 under the control of the processor 202. In one aspect, the network interface 206 may be configured to communicate with the sensor unit 104C disclosed in the detailed description of FIG. 1. In an alternative aspect, the network interface 206 may be configured to receive the sensor data from the OEM cloud 106 over the network 110 as described in FIG. 1. In some example aspects, the network interface 206 may be configured to receive location information of a user associated with a UE (such as, the UE 104), via the network 110. In accordance with an aspect, a controller of the UE 104 may receive the sensor data from a positioning system (for example: a GPS based positioning system) of the UE 104. The network interface 206 may be implemented by use of known technologies to support wired or wireless communication of the system 102 with the network 110. Components of the network interface 206 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/O interface 208 may comprise suitable logic, circuitry, and interfaces that may be configured to operate as an I/O channel/interface between the UE 104 and different operational components of the system 102 or other devices in the network environment 100. The I/O interface 208 may facilitate an I/O device (for example, an I/O console) to receive an input (e.g., sensor data from the UE 104 for a time duration) and present an output to one or more UE (such as, the UE 104) based on the received input. In accordance with an aspect, the I/O interface 208 may obtain the sensor data from the OEM cloud 106 to store in the memory 202. The I/O interface 208 may include various input and output ports to connect various I/O devices that may communicate with different operational components of the system 102. In accordance with an aspect, the I/O interface 208 may be configured to output mitigation and/or confirmation of critical areas to a user device, such as, the UE 104 of FIG.1.

In example aspects, the I/O interface 208 may be configured to provide the data associated with one or more guardrail collisions events to the database 108A to update the map of a certain geographic region. In accordance with an aspect, a user requesting information in a geographic region may be updated about historical (or static) road features, real-time or historical weather conditions, road conditions, road construction, etc. Examples of the input devices may include, but are not limited to, a touch screen, a keyboard, a mouse, a joystick, a microphone, and an image-capture device. Examples of the output devices may include, but are not limited to, a display, a speaker, a haptic output device or other sensory output devices.

In accordance with an aspect, the processor 202 may train the one or more machine learning models 210 to assist in determining a context and likelihood of a vehicle hitting a guardrail. In an aspect of the disclosure, the processor 202 may predict, based on the one or more trained machine learning models in conjunction with ground truth of the region, such as locations of guardrail collision events and their context as derived from a map and one or more sensors along the link, a likelihood that the given vehicle will go over the guardrail into an unsafe area based on the first likelihood and guardrail collision features. In an aspect, a weighted linear regression model may be used to predict, based on the one or more trained machine learning models in conjunction with ground truth of the region, such as locations of guardrail collision events as derived from a map and one or more sensors along the link, a likelihood that the given vehicle will go over the guardrail into an unsafe area based on the first likelihood and guardrail collision features. In another aspect, a look-up table may be used for predicting, based on the one or more trained machine learning models in conjunction with ground truth of the region, such as locations of guardrail collision events as derived from a map and one or more sensors along the link, a likelihood that the given vehicle will go over the guardrail into an unsafe area based on the first likelihood and guardrail collision features.

In another aspect, a machine learning model, such as the one or more trained machine learning models 210 discussed earlier, may be used to determine a context and likelihood of a vehicle hitting a guardrail. In accordance with an aspect, the trained machine learning models 210 may be trained offline to obtain a classifier model to automatically predict, based on the one or more trained machine learning models in conjunction with ground truth of the region, such as locations of guardrail collision events and their context as derived from a map and one or more sensors along the link, a likelihood that the given vehicle will go over the guardrail into an unsafe area based on the first likelihood and guardrail collision features. For the training of the trained machine learning models 210, different feature selection techniques and classification techniques may be used. The system 102 may be configured to obtain the trained machine learning models 210 and the trained machine learning models 210 may leverage historical information and real-time data to automatically predict, based on the one or more trained machine learning models in conjunction with ground truth of the region, such as locations of guardrail collision events and their context as derived from a map and one or more sensors along the link, a likelihood that the given vehicle will go over the guardrail into an unsafe area based on the first likelihood and guardrail collision features. In one aspect, supervised machine learning techniques may be utilized where ground truth data is used to train the model for different scenarios and then in areas where there is not sufficient ground truth data, the trained machine learning models 210 can be used to predict features or results.

In an aspect, the trained machine learning model 210 may be complemented or substituted with a transfer learning model. The transfer learning model may be used when the contextual factors related to likelihood of guardrail collisions, such as a type of vehicle; traffic conditions; day or night when the one or more guardrail collision events occurs; a functional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof are unavailable, sparse, incomplete, corrupted or otherwise unreliable for predicting critical areas in a region. The transfer learning model may then use historical instances of guardrail collision events for predicting guardrail collision events in a new region.

In accordance with an aspect, various data sources may provide the historical and real-time information on guardrail collision events, such as aggregations of locations and conditions leading to guardrail collision events for a given link at a given time as an input to the machine learning models 210. Examples of the machine learning models 210 may include, but not limited to, Decision Tree (DT), Random Forest, and Ada Boost. In accordance with an aspect, the memory 204 may include processing instructions for training of the machine learning model 210 with data set that may be real-time (or near real time) data or historical data. In accordance with an aspect, the data may be obtained from one or more service providers.

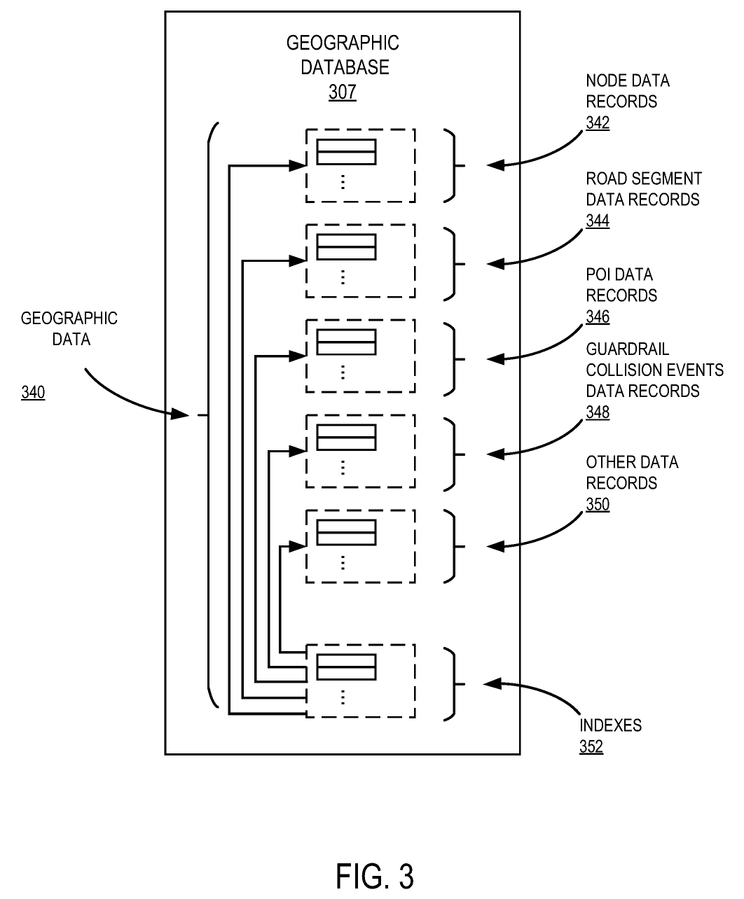

FIG. 3 illustrates an example map or geographic database 307, which may include various types of geographic data 340. The database may be similar to or an example of the database 108B. The data 340 may include but is not limited to node data 342, road segment or link data 344, map object and point of interest (POI) data 346, guardrail collision events data records 348, or the like (e.g., other data records 350 such as traffic data, sidewalk data, road dimension data, building dimension data, vehicle dimension/turning radius data, etc.). Other data records may include computer code instructions and/or algorithms for executing a trained machine learning model that is capable of determining a context and likelihood of a vehicle hitting a guardrail.

A profile of end user mobility graph and personal activity information may be obtained by any functional manner including those detailed in U.S. Patent No. 9,766,625 and U.S. Patent No. 9,514,651, both of which are incorporated herein by reference. This data may be stored in one of more of the databases discussed above including as part of the guardrail collision events records 348 in some aspects. This data may also be stored elsewhere and supplied to the system 102 via any functional means.

In one aspect, the following terminology applies to the representation of geographic features in the database 307. A “Node” – is a point that terminates a link, a “road/line segment” – is a straight line connecting two points., and a “Link” (or “edge”) is a contiguous, non-branching string of one or more road segments terminating in a node at each end. In one aspect, the geographic database 307 follows certain conventions. For example, links do not cross themselves and do not cross each other except at a node. Also, there are no duplicated shape points, nodes, or links. Two links that connect each other have a common node.

The geographic database 307 may also include cartographic data, routing data, and/or maneuvering data as well as indexes 352. According to some example aspects, the road segment data records may be links or segments representing roads, streets, or paths, as may be used in calculating a route or recorded route information for determination of guardrail collision events for an area. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the geographic database 307 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The geographic database 307 can include data about the POIs and their respective locations in the POI records. The geographic database 307 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The geographic database 307 may be maintained by a content provider e.g., the map data service provider and may be accessed, for example, by the content or service provider processing server. By way of example, the map data service provider can collect geographic data and dynamic data to generate and enhance the map database and dynamic data such as weather- and traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The geographic database 307 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the geographic database 307 may be a master geographic database, but in alternate aspects, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The guardrail collision event records 348 may include various points of data such as, but not limited to: a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link, a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof.

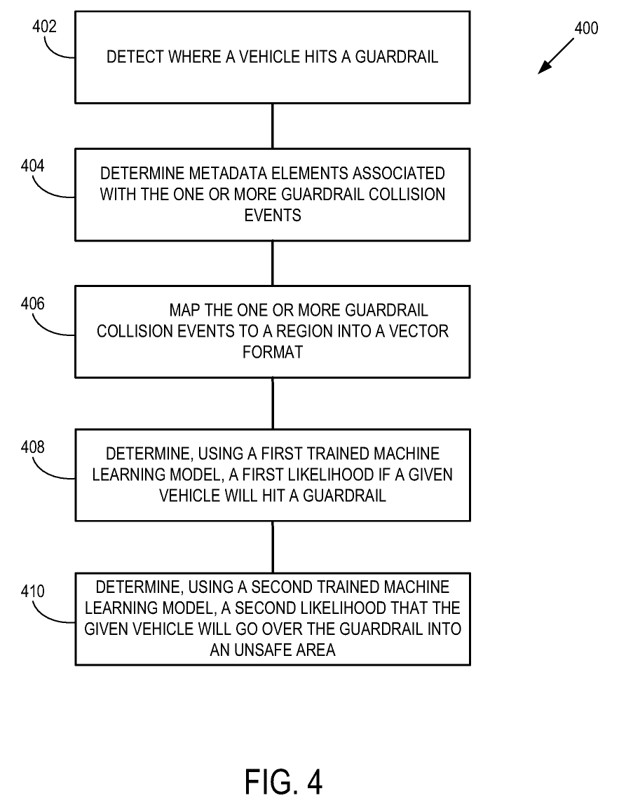

FIG. 4 illustrates a flowchart 400 for acts taken in an exemplary method for determine a context and likelihood of a vehicle hitting a guardrail, in accordance with an aspect. More, fewer or different steps may be provided. FIG. 4 is explained in conjunction with FIG. 1 to FIG. 3. The control starts at act 402.

At act 402, the system 102 may detect, by sensors, where a vehicle hits a guardrail in one or more guardrail collision events. In an aspect, the detection may be in the form of probe data collected from vehicles and surrounding locations; front facing cameras in vehicles; cameras from other vehicles; head-mounted devices/glasses; vehicle sensors or other vehicles' sensors; traffic/safety cameras, or a combination thereof.

At act 404, the system 102 may determine metadata elements associated with the one or more guardrail collision events. In an aspect, the metadata elements may include a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link; or a combination thereof.

At act 406, the system 102 may mapping the one or more guardrail collision events to a region into a vector format. In an aspect, the mapping may be done on an aggregated basis, such as city, country, regional or state level data of guardrail collision events.

At act 408, the system 102 may determine, using a first trained machine learning model, a first likelihood if a given vehicle will hit a guardrail in the region on a given link at a given time based on the mapped guardrail collision events and a training feature dataset. In an aspect, the training feature dataset may include a type of vehicle; traffic conditions; day or night when the one or more guardrail collision events occurs; a functional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof. In an aspect, the first trained machine model may include a standard regression model or a classification model.

At act 410, the system 102 may determine, using a second trained machine learning model, a second likelihood that the given vehicle will go over the guardrail into an unsafe area based on the first likelihood and guardrail collision features. In an aspect, the guardrail collision features may include at least one of an incidence angle of the one or more guardrail collision events, a speed during the one or more guardrail collision events, a slope of a landscape where the guardrail is located or a combination thereof.

In an aspect, the system 102 may use a transfer learning model based on the second trained machine learning model in a new area different from the one or more areas used in generating the second trained machine learning model.

In an aspect, the system 102 may generat the second trained machine learning model by using a mobility graph of historical data of one or more drivers involved in the one or more guardrail collision events.

It may be contemplated that various applications of the disclosed system 102 may arise in usage. In an aspect, once the ML models have been trained and the system 102 has identified the contexts (locations/areas, time, weather, etc) leading to vehicles hitting guardrails, there may be applications the system 102 could contextually make use of:

### Mapping application:

Showing on the map the areas which have lots of such accidents (e.g., at this time of the day or under current context of traffic and weather conditions)

### Routing:

Consider such input for the routing algorithm, to avoid such areas when possible or if the context is deemed too improper (eg. a heavy slope going down and curve at the end of the road on a snowy/icy day for a truck)..

### Guidance:

The system 102 could make audio guidance outputs like: “Pay attention, this area is known to be have vehicles hitting the guardrail, so beware of this”

Visual guidance: by visually highlighting the risk related to those dangerous areas, protected by the guardrails.

### Warning:

Warn people to pay special attention at some given locations and time, e.g., just before a curve or after overtaking on the highway, which is often where people lose control of their vehicle.

### Urban planning and design:

All the learning and insights from the ML models may be used to inform road infrastructures update, improvements and new projects. Such data should be used to support the many ways which guardrails could be made safer.

### Improved placement:

Careful consideration of where guardrails are placed can help to ensure:

1. That they are more effective at protecting all kinds of drivers.

2. Enhanced visibility: making guardrails more visible, for example by using reflective tape or paint, can help to alert drivers to their presence and reduce the risk of a crash.

3. Improved design: guardrails can be designed in such a way as to better absorb impact energy and reduce the severity of crashes.

For example, using stronger materials or adding features like breakaway posts and energy-absorbing end treatments can help to improve the performance of guardrails.

If the ML models shows that motorbike riders are the most likely to hit a given guardrail, then the design for this location should be adapted to protect optimally those riders.

4. Better maintenance: regular maintenance of guardrails, such as inspecting and replacing damaged or weakened components, can help to ensure that they are in good working order and able to provide maximum protection to drivers.

In an aspect, the disclosed system 102 may be used to benefit Autonomous Vehicles (AVs). AVs would be interested in knowing where and when they would more likely to face dangerous situations involving cars which have hit a guardrail and which may end up stopped in the middle of the road or on opposite lanes. With this data, they can use this as an input into their risk calculation algorithm (to avoid such areas) and their routing algorithm.

As mentioned before, motorbike riders are very vulnerable and guardrails can be deadly for them. Accidents involving motorbikes do not only mean direct hit against guardrails but also braking maneuvers or maneuvers made to avoid other vehicles, pedestrians or objects, causing the rider to fall and slide till hitting the guardrail. The disclosed system 102 must learn from historical data what are the main causes for such accidents in order to be able to recommend the proper actions to improve the situation.

In another aspect, such prediction models in ADAS features to make roads safer. Indeed, reducing the likelihood to accidents against guardrails would greatly reduce the risks of accidents in those areas. Similarly, knowing where and when such accidents are more likely to happen can be a useful input to the ADAS system.

Blocks of the flowchart 400 support combinations of means for performing the specified functions and combinations of operations for performing the specified functions for performing the specified functions. It will also be understood that one or more blocks of the flowchart 500, and combinations of blocks in the flowchart 500, can be implemented by special purpose hardware-based computer systems which perform the specified functions, or combinations of special purpose hardware and computer instructions.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

Although the aforesaid description of FIGS. 1-4 is provided with reference to the sensor data, however, it may be understood that the disclosure would work in a similar manner for different types and sets of data as well. The system 102 may generate/train the machine learning models 210 to evaluate different sets of data at various geographic locations. The update may be provided as a run time update or a pushed update.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an aspect of the present disclosure and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer implemented method to determine a context and likelihood of a vehicle hitting a guardrail, the method comprising:
detecting, by sensors, where a vehicle hits a guardrail in one or more guardrail collision events;
determining metadata elements associated with the one or more guardrail collision events;
mapping the one or more guardrail collision events to a region into a vector format;
determining, using a first trained machine learning model, a first likelihood if a given vehicle will hit a guardrail in the region on a given link at a given time based on the mapped guardrail collision events and a training feature dataset; and
determining, using a second trained machine learning model, a second likelihood that the given vehicle will go over the guardrail into an unsafe area based on the first likelihood and guardrail collision features.

2. The method of claim 1, where detecting, by sensors, where the vehicle hits the guardrail in one or more guardrail collision events comprises detecting the one or more guardrail collision events with probe data collected from vehicles and surrounding locations; front facing cameras in vehicles; cameras from other vehicles; head-mounted devices/glasses; vehicle sensors or other vehicles' sensors; traffic/safety cameras, or a combination thereof.

3. The method of claim 1, where the metadata elements comprise at least one of a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link; or a combination thereof.

4. The method of claim 1, where the training feature dataset comprises at least one of a type of vehicle; traffic conditions; day or night when the one or more guardrail collision events occurs; afunctional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof.

5. The method of claim 1, where the first trained machine model comprises a standard regression model or a classification model.

6. The method of claim 1, where the guardrail collision features comprises at least one of an incidence angle of the one or more guardrail collision events, a speed during the one or more guardrail collision events, a slope of a landscape where the guardrail is located or a combination thereof.

7. The method of claim 1, further comprising using a transfer learning model based on the second trained machine learning model in a new area different from the one or more areas used in generating the second trained machine learning model.

8. The method of claim 1, further comprising generating the second trained machine learning model by using a mobility graph of historical data of one or more drivers involved in the one or more guardrail collision events.

9. A system to determine a context and likelihood of a vehicle hitting a guardrail, comprising:
at least one memory configured to store computer executable instructions; and
at least one processor configured to execute the computer executable instructions to:
detect, by sensors, where a vehicle hits a guardrail in one or more guardrail collision events;
determine metadata elements associated with the one or more guardrail collision events;
map the one or more guardrail collision events to a region into a vector format;
determine, using a first trained machine learning model, a first likelihood if a given vehicle will hit a guardrail in the region on a given link at a given time based on the mapped guardrail collision events and a training feature dataset; and
determine, using a second trained machine learning model, a second likelihood that the given vehicle will go over the guardrail into an unsafe area based on the first likelihood and guardrail collision features.

10. The system of claim 9, where the computer executable instructions to detect, by sensors, where the vehicle hits the guardrail in one or more guardrail collision events comprise computer executable instructions to detecti the one or more guardrail collision events with probe data collected from vehicles and surrounding locations; front facing cameras in vehicles; cameras from other vehicles; head-mounted devices/glasses; vehicle sensors or other vehicles' sensors; traffic/safety cameras, or a combination thereof.

11. The system of claim 9, where the metadata elements comprise at least one of a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link; or a combination thereof.

12. The system of claim 9, where the training feature dataset comprises at least one of a type of vehicle; traffic conditions; day or night when the one or more guardrail collision events occurs; afunctional class of the link; a type of the guardrail; a road width; a presence of physical divider; extreme weather conditions; a vehicle speed; a heading degree difference; an incidence angle; a road curvature; a road ascent/descent degree; a presence of road works; a presence of tree or infrastructure on the edge of the link; a type of vehicle transmission; or a combination thereof.

13. The system of claim 9, where the first trained machine model comprises a standard regression model or a classification model.

14. The system of claim 9, where the guardrail collision features comprises at least one of an incidence angle of the one or more guardrail collision events, a speed during the one or more guardrail collision events, a slope of a landscape where the guardrail is located or a combination thereof.

15. The system of claim 9, further comprising computer executable instructions to use a transfer learning model based on the second trained machine learning model in a new area different from the one or more areas used in generating the second trained machine learning model.

16. The system of claim 9, further comprising computer executable instructions to generate the second trained machine learning model by using a mobility graph of historical data of one or more drivers involved in the one or more guardrail collision events.

17. A computer program product comprising a non-transitory computer readable medium having stored thereon computer executable instructions, which when executed by one or more processors, cause the one or more processors to carry out operations to determine a context and likelihood of a vehicle hitting a guardrail, the operations comprising:
detecting, by sensors, where a vehicle hits a guardrail in one or more guardrail collision events;
determining metadata elements associated with the one or more guardrail collision events;
mapping the one or more guardrail collision events to a region into a vector format;
determining, using a first trained machine learning model, a first likelihood if a given vehicle will hit a guardrail in the region on a given link at a given time based on the mapped guardrail collision events and a training feature dataset; and
determining, using a second trained machine learning model, a second likelihood that the given vehicle will go over the guardrail into an unsafe area based on the first likelihood and guardrail collision features.

18. The computer program product of claim 17, further comprising operations for detecting, by sensors, where the vehicle hits the guardrail in one or more guardrail collision events comprises operations for detecting the one or more guardrail collision events with probe data collected from vehicles and surrounding locations; front facing cameras in vehicles; cameras from other vehicles; head-mounted devices/glasses; vehicle sensors or other vehicles' sensors; traffic/safety cameras, or a combination thereof.

19. The computer program product of claim 17, where the metadata elements comprise at least one of a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link; or a combination thereof.

20. The computer program product of claim 17, where the metadata elements comprise at least one of a time of the event; a start of the one or more guardrail collision events; a duration/length of the one or more guardrail collision events; an end of the one or more guardrail collision events; a number of vehicles impacted by the one or more guardrail collision events; a speed of the vehicle; weather conditions; visibility; traffic conditions; a functional class of the link; or a combination thereof.
